(19) United States
(12) Patent Application Publication
(10) Pub. No.: US 2003/0225772 A1
(43) Pub. Date: Dec. 4, 2003

(54) Business method for determining required product configurations to meet varied performance requirements

(75) Inventor: Howard Sykes, Durham, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/160,922

(22) Filed: May 31, 2002

(51) Int. Cl. G06F 17/00

(52) U.S. Cl. 707/100

(57) ABSTRACT

A method of doing business is disclosed which utilizes a set of databases and tables to efficiently produce competitive product configurations which meet customers requirements for various workloads using different and changing specifications. Each recommended product must only use currently available parts and account for changes in standard and optional components. The method is designed to configure products to be manufactured on a worldwide basis. Much of the customer's requirement input can automatically be filled in from secondary data sources eliminating keying errors and identifying invalid configurations. Additional design features of the method include a unique structure that allows both the data and the database design, vs. just the data, to be used by programs so that as new components are added, programs do not need to be updated to reflect the changes to the structure of the database design.

### BACKGROUND OF THE INVENTION

This invention pertains to database management systems and, more particularly, to a method for determining product configurations which meet varied performance requirements.

Database management systems have use in methods of doing business as the underlying engine providing day to day transactions to application programs seeking up-to-date data. Typically, no problem is presented when updates are made to the data in the database so long as the structure of the database itself remains static, or at least supports all queries which can initiate from the application programs. The application programs are typically maintained such that when updates are made to the structure of the database, changes to the application programs which access the database also need to be updated. At the very least, any new features supported by an updated database cannot be used until the application programs are updated. However, updates to the application programs and the coordination between the application program updates to the database structural updates can be a time consuming and arduous task.

When used to configure products, often it is desirable for a business method to be able to configure products for world wide production, distribution and sale. This can involve maintaining different databases and application programs separately for each country. However, maintaining separate databases and application programs is wrought with inefficiency relating to resources required as well as to down time and to database synchronization.

Methods, program products, and apparatus implementing the same, which employ underlying relational databases, often require an overabundance of manual keying which could lead to keying errors. Similarly, methods, programs products, and apparatus implementing the same which do not identify invalid configurations or account for changes in standard and optional components or fail to recommend currently available parts are less than optimal.

### SUMMARY OF THE INVENTION

Briefly, a relational database is maintained with up-to-date data. The relational database includes meta-data which reflects the current structure of the relational database such that programs, which include maintenance and access programs, can retrieve the meta-data. The relational database contains information relating to products or product attributes or options to be configured or sized. The relational database is designed to be accessed by the product attributes. An access to any given product attribute returns the associated attribute data. Any of the secondary databases can be used as a source for providing or deriving any data associated with any attribute. The relational database is queried for the meta-data and a requirements dialog is generated for customer input. The dialog is formed in consideration of the meta-data and in this manner the dialog reflects the current structure of the relational database. Customer input data is accepted which indicates the customer's requirements. An association is made between the customer's requirements and a set of underlying basics. Finally, the relational database is accessed as a function of the underlying basics and the customer's requirements and a recommendation is generated for customer presentation containing one or more configured products which meet the customer's requirements.

### BRIEF DESCRIPTION OF THE DRAWINGS

Some of the purposes of the invention having been stated, others will appear as the description proceeds, when taken in connection with the accompanying drawings, in which:

FIG. 1 is a block diagram of the data flow of one embodiment of the present invention utilizing multiple databases and tables.

FIG. 2 is a block diagram interrelating the steps of an embodiment of the present invention to their respective database components.

FIG. 3 is a flow chart of the major steps of one embodiment of the present invention.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

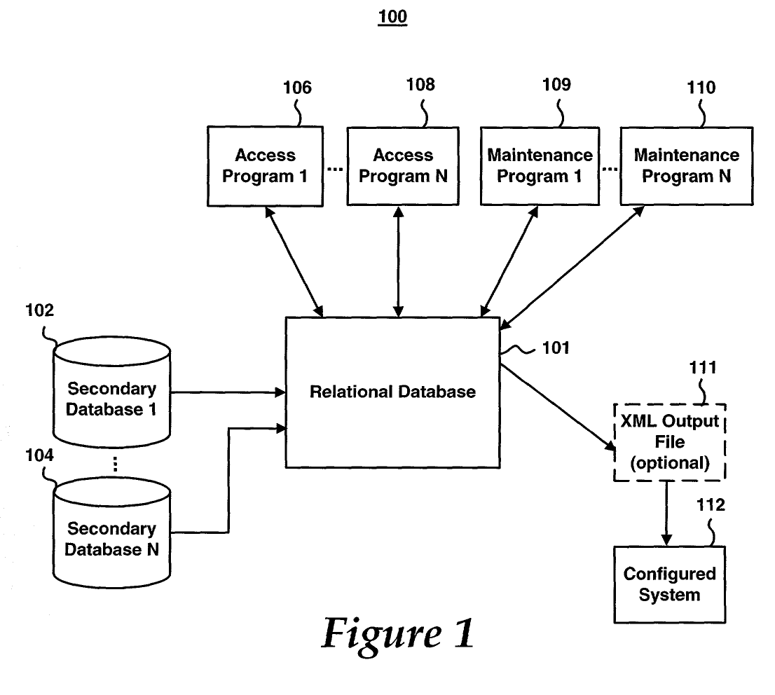

Referring now more particularly to the accompanying drawings, FIG. 1 depicts the data flow of a preferred embodiment utilizing multiple databases and tables 100. A relational database 101 is maintained with the latest and most up-to-date information relating to all aspects of configuring products which meet certain criteria. In the preferred embodiment, the products to be configured are computer systems and related options. In this embodiment, relational database 101 contains computer system sizing attribute information such as physical dimensions, weight, number of processors, processor speed, power specifications, hard disk drive size, number of hard disk drives, type and amount of memory, etc. and also includes subassemblies such as available machine types and model numbers meeting certain criteria. In other embodiments, relational database 101 can be maintained to configure automobiles, airplanes, shipping vessels, or any other product which is assembled from a set of subassemblies and parts including optional components related to the product to be assembled.

The relational database 101 can be implemented wholly or in part using any available relational database products available at the time of this writing which include the functionality described herein. For example, the available relational database products can be Structured Query Language (SQL) database products, or database products where the database design components are arranged in columns, or database products which are accessed by attribute type where such access returns the associated attribute values.

Each of the aforementioned computer system sizing attributes are associated with each of the columns of relational database 101. Such that, the attributes are accessed by accessing database columns. Accessing any column can return any and all attributes associated with that column. For example, if a column represents the color for the computer system, the attributes returned can contain the respective values of beige and black. In another example, if a column indicates whether a particular part or subassembly is rack mountable, the attributes returned can contain the values “Yes” and “No.” Further, relational database 101 contains meta-data about the relational database itself. Accessing this meta-data returns data which indicates the structure of relational database 101 at the time of the access.

Relational database 101 is constantly maintained by maintenance programs 109 and 110 such that access to data represents the most currently available components, options, and subassemblies. The up-to-date character of relational database 101 allows for such consideration as the availability of parts, parts introduction, parts withdrawal and further can include country dependent availability, introduction, and withdrawal. Maintaining and using the database in this fashion automatically handles product introduction and withdrawal worldwide by country.

Any of the database design components, i.e., the columns of relational database 101, or any of the attributes within any of the database design components, as an alternative to being maintained by maintenance programs 109 and 110, can be linked to one of the secondary databases 102 and 104. This linking has the effect of automatically maintaining the attribute values to the latest information stored in these secondary databases. There can be any number of secondary databases 102 and 104. The data supplied by secondary databases 102 and 104 can be used directly as attribute data or alternatively can be used to derive attribute data.

For example the secondary databases 102 and 104 can contain current parts' availability data. In this way, the date of product delivery can be factored into the sizing. The availability of parts can be organized by country such that, when a single global part's database is maintained, product introduction and withdrawal are automatically effected world wide.

Secondary databases 102 and 104 can contain International Standards Organization (ISO) country number data. In this example, ISO country number data is maintained by a separate in-house or independent external authority. In this manner, ISO country number data will always be up-to-date.

Secondary databases 102 and 104 can contain performance specification data. Examples of performance specification data include processor speed, processor front side bus speed, processor memory bandwidth, memory format, memory speed, and memory latency.

The multiple databases and tables 100 are utilized such that many of the attributes are automatically filled in from the secondary databases 102 and 104 as the information in secondary databases 102 and 104 are updated on the fly. Such use of multiple databases and tables 100 help in eliminating keying errors and identifying invalid configurations as the information in secondary databases 102 and 104 changes.

Relational database 101 is accessed by access programs 106 and 108. Any number of access programs 106 and 108 can be used. Access programs 106 and 108 can have any function which requires access to relational database 101. One exemplary use for access programs 106 and 108 is as a customer dialog and interface. A dialog is presented for customer input. Once customer input is accepted, the access program 106 and 108 queries the relational database 101 using customer input and other criteria. The relational database 101 generates a list of recommended configured systems 112. Optionally, the output format of relational database 101 can be a file such as XML output file 111. Given a single set of input customer requirements, relational database 101 can recommend multiple system configurations 112 based upon the parts availability in existence at the time of the query. As part of the query, predetermined customer requirements which tend to be high-level application based parameters are broken down into underlying basics. These underlying basics are more closely aligned to part specifications and subassembly characteristics than to the customer's requirements. Examples of these underlying basics include estimated performance ratings, CPU speed expressed in instructions per second, number of slots, etc.. As an example of a customer's requirement, let us assume that the application is for and email server computer configuration. In this example, customer requirement requirements refers to the total number of mailboxes, the average mailbox size, any amount of additional storage, the level of server availability desired, whether or not tape backup should be included in the sizing, whether RAID technology should be included in the sizing, the type and rpm specification of hard disk drive to be used, the projected growth of the user base, the life span, whether or not a redundant power supply is to be used, etc..

Where the association of underlying basics for some attributes are either too complex to be automatically generated or are subjective and require human input, the association between customer requirements and underlying basics can be developed by performance engineering personnel who make studies of predetermined standard requirements and ascertain the appropriate underlying basics based on the specifications of the available hardware options. Where the association of customer requirements and underlying basics is objective or otherwise does not require human input, the access program can make the association given only the meta-data when a new database component is added.

Access programs 106 and 108 and maintenance programs 109 and 110 can be implemented or written using any of the currently available database management systems such as Microsoft Access 2000™. Access programs 106 and 108 and maintenance programs 109 and 110 can alternatively be implemented using INTERNET Web based tools if Internet access is desired. Alternatively, access programs 106 and 108 and maintenance programs 109 and 110 can be implemented using spreadsheet tools including any language supporting a database application programming interface (API). Examples of such language supporting database API include Java™ and Perl® (Java is a trademark of Sun Microsystems, other trademarks used herein are property of their respective owners). This allows for easier access to differing data sources and analysis using the most appropriate software package for each given task.

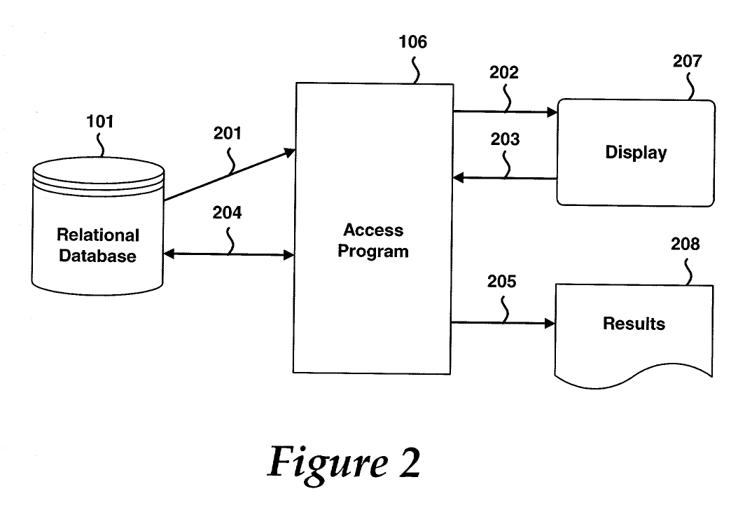

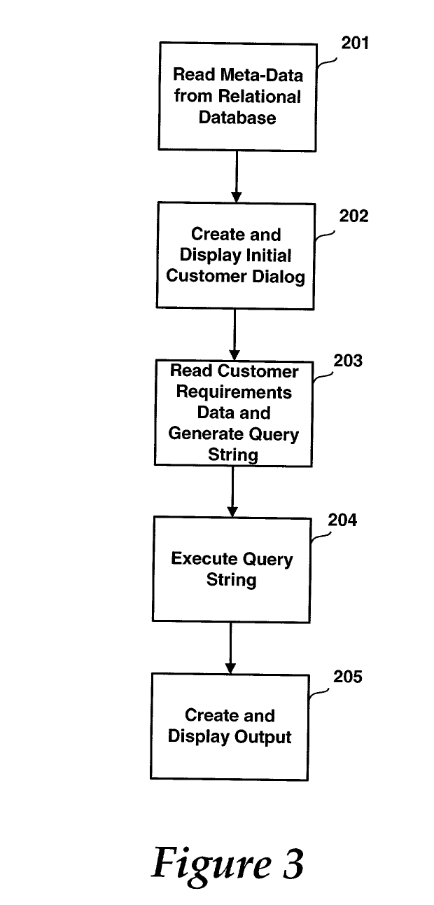

One aspect of the present embodiment is that access programs 106 and 108 and maintenance programs 109 and 110 need not be updated as updates to relational database 101 and secondary databases 102 and 104 are made. Furthermore, the behavior of access programs 106 and 108 and maintenance programs 109 and 110 are able to change without need for changes in the access and maintenance programs themselves through the use of a standardized model. This change of program behavior is triggered by either a change in database attribute values, or a change in the structure of the database itself. How the standardized model meets these requirements is explained in further detail relative to FIGS. 2 and 3 in the text that follows.

Referring now to FIG. 2 and FIG. 3, the access program 106 is executed to aid a customer in providing requirements and in guiding the customer towards a set of product configurations and options which meet the requirements. The customer can then select the best match from the set of product configurations and options. Access program 106 is written to a standardized model. The standardized model is a database model that allows access program 106 to access attributes of data, known as meta-data, so that access program 106 can handle the changing structure and design of relational database 101 without need for changing access program 106 itself. This is implemented by steps 201 through 205. In step 201, access program 106 accesses relational database 101 and reads meta-data which reflects the current structure and design of database 101. When implemented as tables, the meta-data contains information about each column in relational database 101. In this example, different columns of relational database 101 are used to contain different attribute types, classes, or groups. For example, the attribute types, classes, or groups can represent “Color” vs. its associated attribute values such as white or black. In this case, the meta-data includes “Color”. Using this information, access program 106 in step 202 can create a dialog for display 207 to the customer which solicits their requirements for each type of configuration option. In step 203 the customer's requirements input is read. Using the customer's input plus the relational database 101 meta-data which includes the names of each database column, access program 106 creates a source database query string. In step 204 the program-created query string is compiled and executed in real time. Executing the string results in relational database 101 being searched to find the best solutions to the customer's requirements and business requirements such as product availability based upon the underlying basics as stated supra. In step 205 output results 208 are created and displayed to the customer showing the product(s) that meet their requirements.

In the drawings and specifications there has been set forth a preferred embodiment of the invention and, although specific terms are used, the description thus given uses terminology in a generic and descriptive sense only and not for purposes of limitation.

What is claimed is:

1. A method comprising the steps of:
(A) providing an up-to-date relational database having meta-data which reflects the current structure of the relational database and accessible by product attributes wherein an access to any given product attribute returns attribute associated data;
(B) querying the relational database for the meta-data and generating a requirements dialog for customer input as a function of the meta-data which reflects the current structure of the relational database;
(C) accepting customer input data indicating customer requirements;
(D) associating the customer requirements to a set of underlying basics; and
(E) accessing the relational database based on the underlying basics and generating a recommendation for customer presentation containing at least one configured product which meets the customer requirements.

2. The method of claim 1 wherein said providing step (A) further comprises the step of accessing a second database which provides data for deriving at least one of the attribute associated data; and wherein said querying step (B), said accepting step (C), said associating step (D), and said accessing step (E) are performed by an access program which remains unchanged while the requirements dialog changes in concert with changes in the meta-data which reflects the current structure of the relational database.

3. The method of claim 2 wherein the access program is database management system based.

4. The method of claim 2 wherein the access program is INTERNET Web based.

5. The method of claim 2 wherein the access program is spreadsheet based.

6. The method of claim 2 wherein the access program is written in a programming language supporting a database application programming interface (API).

7. The method of claim 2 wherein the attribute associated data is current parts availability data.

8. The method of claim 2 wherein the attribute associated data is International Standards Organization (ISO) country number data.

9. The method of claim 2 wherein the attribute associated data is performance specification data.

10. A business method comprising the steps of:
(A) providing an up-to-date database organized by columns having meta-data which reflects the current structure of the database and accessible by product sizing attributes wherein an access to any given product sizing attribute returns attribute associated data and wherein the structure of the database is subject to constant change via the addition and deletion of database columns representing database design components;
(B) accessing a second database which provides data for deriving at least one of the attribute associated data;
(C) associating a predetermined set of customer requirements to a set of underlying basics; and
(D) executing an access program effective in:
(1) querying the database for the meta-data and generating a requirements dialog for customer input as a function of the meta-data which reflects the current structure of the database;
(2) accepting customer input data indicating customer requirements;
(3) generating a query string based upon the customer input data and the meta-data which reflects the current structure of the database; and
(4) accessing the database based on the execution of the query string and generating based upon the underlying basics a recommendation for customer presentation containing at least one configured product which meets the customer requirements;
wherein the access program remains unchanged while the requirements dialog changes in concert with the changes to the structure of the database via the addition and deletion of database columns representing database design components and in concert with the meta-data which reflects the current structure of the database.

11. The method of claim 10 wherein the accessing step (4) further comprises a mapping of the customer requirements to the predetermined set of customer requirements.

12. The method of claim 10 wherein the access program is database management system based.

13. The method of claim 10 wherein the access program is INTERNET Web based.

14. The method of claim 10 wherein the access program is spreadsheet based.

15. The method of claim 10 wherein the access program is written in a programming language supporting a database application programming interface (API).

16. The method of claim 10 wherein the attribute associated data is current parts availability data.

17. The method of claim 10 wherein the attribute associated data is International Standards Organization (ISO) country number data.

18. The method of claim 10 wherein the attribute associated data is performance specification data.

19. A program product comprising:
a computer readable medium;
a computer executable program stored on said computer readable medium, said computer executable program being effective in executing the steps of:
(A) providing an up-to-date relational database having meta-data which reflects the current structure of the relational database and accessible by product attributes wherein an access to any given product attribute returns attribute associated data;
(B) querying the relational database for the meta-data and generating a requirements dialog for customer input as a function of the meta-data which reflects the current structure of the relational database;
(C) accepting customer input data indicating customer requirements;
(D) associating the customer requirements to a set of underlying basics; and
(E) accessing the relational database based on the underlying basics and generating a recommendation for customer presentation containing at least one configured product which meets the customer requirements.

20. The program product of claim 19 wherein the providing step (A) of said computer executable program is further effective in accessing a second database which provides data for deriving at least one of the attribute associated data; and wherein said querying step (B), said accepting step (C), said associating step (D), and said accessing step (E) are performed by an access program which remains unchanged while the requirements dialog changes in concert with changes in the meta-data which reflects the current structure of the relational database.

21. The program product of claim 20 wherein the access program is database management system based.

22. The program product of claim 20 wherein the access program is INTERNET Web based.

23. The program product of claim 20 wherein the access program is spreadsheet based.

24. The program product of claim 20 wherein the access program is written in a programming language supporting a database application programming interface (API).

25. The program product of claim 20 wherein the attribute associated data is current parts availability data.

26. The program product of claim 20 wherein the attribute associated data is International Standards Organization (ISO) country number data.

27. The program product of claim 20 wherein the attribute associated data is performance specification data.

28. A program product comprising:
a computer readable medium;
a computer executable program stored on said computer readable medium, said computer executable program being effective in executing the steps of:
(A) providing an up-to-date database organized by columns having meta-data which reflects the current structure of the database and accessible by product sizing attributes wherein an access to any given product sizing attribute returns attribute associated data and wherein the structure of the database is subject to constant change via the addition and deletion of database columns representing database design components;
(B) accessing a second database which provides data for deriving at least one of the attribute associated data;
(C) associating a predetermined set of customer requirements to a set of underlying basics; and
(D) executing an access program effective in:
(1) querying the database for the meta-data and generating a requirements dialog for customer input as a function of the meta-data which reflects the current structure of the database;
(2) accepting customer input data indicating customer requirements;
(3) generating a query string based upon the customer input data and the meta-data which reflects the current structure of the database; and
(4) accessing the database based on the execution of the query string and generating based upon the underlying basics a recommendation for customer presentation containing at least one configured product which meets the customer requirements;
wherein the access program remains unchanged while the requirements dialog changes in concert with the changes to the structure of the database via the addition and deletion of database columns representing database design components and in concert with the meta-data which reflects the current structure of the database.

29. The program product of claim 28 wherein the accessing step (4) further comprises a mapping of the customer requirements to the predetermined set of customer requirements.

30. The program product of claim 28 wherein the access program is database management system based.

31. The program product of claim 28 wherein the access program is INTERNET Web based.

32. The program product of claim 28 wherein the access program is spreadsheet based.

33. The program product of claim 28 wherein the access program is written in a programming language supporting a database application programming interface (API).

34. The program product of claim 28 wherein the attribute associated data is current parts availability data.

35. The program product of claim 28 wherein the attribute associated data is International Standards Organization (ISO) country number data.

36. The method of claim 28 wherein the attribute associated data is performance specification data.

37. An apparatus comprising:
a first module which provides data stored in an up-to-date relational database having meta-data which reflects the current structure of the relational database wherein the data is accessible by product attributes wherein an access to any given product attribute returns attribute associated data;
a second module which accesses data stored in a second database which provides data for deriving at least one of the attribute associated data;
a third module which queries the relational database for the meta-data and generates a requirements dialog for customer input as a function of the meta-data which reflects the current structure of the relational database;
a fourth module which accepts customer input data indicating customer requirements;
a fifth module which associates the customer requirements to a set of underlying basics; and
a sixth module which accesses the relational database based on the underlying basics and generates a recommendation for customer presentation containing at least one configured product which meets the customer requirements.
